(19) United States
(12) Patent Application Publication
(10) Pub. No.: US 2013/0011148 A1
(43) Pub. Date: Jan. 10, 2013

(54) INFORMATION PROCESSING APPARATUS, IMAGE FORMING APPARATUS, COMPUTER READABLE MEDIUM STORING PROGRAM, AND INFORMATION PROCESSING METHOD

(75) Inventors: Tadashi KIYAMA, Kanagawa (JP); Toshie NAKAMOTO, Kanagawa (JP); Hiroki ANDO, Kanagawa (JP)

(73) Assignee: FUJI XEROX CO., LTD., Tokyo (JP)

(21) Appl. No.: 13/405,982

(22) Filed: Feb. 27, 2012

(30) Foreign Application Priority Data
Jul. 7, 2011 (JP) 2011-150874

(51) Int. Cl. G03G 21/12

(52) U.S. Cl. 399/35

(57) ABSTRACT

An information processing apparatus for an image forming apparatus including an image forming section that forms toner images based on first image data transferred onto a recording medium and based on second image data that is not transferred and a toner recovery section that recovers residual toner to a recovery container is provided. The information processing apparatus includes a first obtaining part that obtains image amounts representing toner amounts used for the respective toner images when a toner amount recovered to the recovery container reaches a first permissible amount, a correction part that corrects the respective image amounts by using correction factors set for the first and second image data, and an output part that outputs notification information indicating that the toner amount in the recovery container reaches a second permissible amount when a cumulative value of the corrected image amounts reaches a first threshold.

### CROSS-REFERENCE TO RELATED APPLICATIONS

This application is based on and claims priority under 35 USC 119 from Japanese Patent Application No. 2011-150874 filed Jul. 7, 2011.

### BACKGROUND

### Technical Field

The present invention relates to an information processing apparatus, an image forming apparatus, a computer readable medium storing a program, and an information processing method.

### SUMMARY

According to an aspect of the invention, there is provided an information processing apparatus for an image forming apparatus that includes an image forming section that forms a toner image based on first image data that is transferred onto a recording medium and a toner image based on second image data that is not transferred onto the recording medium and a toner recovery section that recovers residual toner in the image forming section to a recovery container, the information processing apparatus including: a first obtaining part that obtains each of image amounts representing toner amounts used for the respective toner images of the first image data and the second image data that are formed by the image forming apparatus in a case where a toner amount recovered to the recovery container reaches a predetermined first permissible amount; a correction part that corrects the respective image amounts of the first image data and the second image data obtained by the first obtaining part by using a correction factor previously set for each of the first image data and the second image data; and an output part that outputs notification information indicating that the toner amount in the recovery container reaches a second permissible amount in a case where a cumulative value obtained by combining the image amount of the first image data and the image amount of the second image data that are corrected by the correction part reaches a predetermined first threshold.

### BRIEF DESCRIPTION OF THE DRAWINGS

Exemplary embodiments of the present invention will be described in detail based on the following figures, wherein:

FIG. 1 illustrates a configuration example of an image forming apparatus according to an exemplary embodiment;

FIGS. 2A and 2B illustrate a configuration example of an image forming section according to the exemplary embodiment;

FIG. 3 represents a toner recovery container according to the exemplary embodiment;

FIG. 4 illustrates functional blocks of a controller according to the exemplary embodiment;

FIG. 5 exemplifies a correction factor table according to the exemplary embodiment;

FIG. 6 is an operational flow diagram illustrating a prediction process according to the exemplary embodiment;

FIG. 7 represents transitions of a cumulative page number and a cumulative pixel count according to the exemplary embodiment;

FIG. 8 exemplifies a correction factor table according to a modified example (1);

FIG. 9 exemplifies a correction factor table according to a modified example (2); and

FIG. 10 exemplifies a correction factor table according to a modified example (3).

### DETAILED DESCRIPTION

Outline

An information processing apparatus according to an exemplary embodiment of the present invention predicts a toner amount in a recovery container where residual toner that is not transferred is recovered in an image forming apparatus. Hereinafter, an image forming apparatus including the information processing apparatus according to the exemplary embodiment of the present invention will be described.

### Configuration

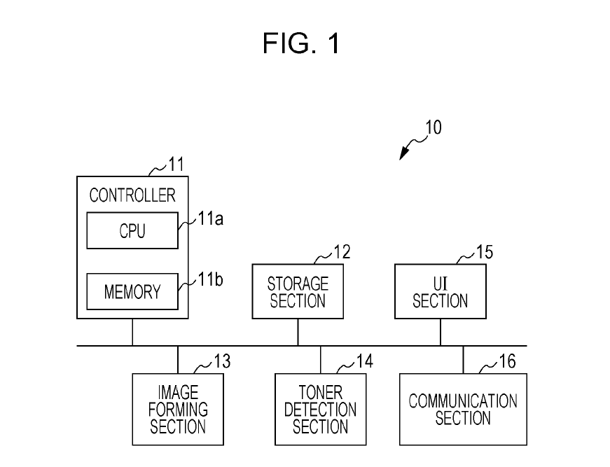

FIG. 1 illustrates a configuration example of an image forming apparatus according to the present exemplary embodiment. An image forming apparatus 10 is a printer based on an electrophotographic system. As illustrated in FIG. 1, the image forming apparatus 10 has a controller 11, a storage section 12, an image forming section 13, a toner detection section 14, a UI section 15, and a communication section 16.

The controller 11 has a central processing unit (CPU) 11a and a memory 11b including a read only memory (ROM) and a random access memory (RAM). The CPU 11a controls the respective sections connected to the controller 11 by executing a control program stored in the ROM or the storage section 12. To be more specific, the CPU 11a causes the image forming section 13 to perform an image forming process of forming an image based on image data specified by a PC that is not illustrated (hereinafter, referred to as specified image) via the communication section 16 on a recording medium such as a sheet. The CPU 11a also performs a prediction process of predicting a deposit amount in the recovery container for the toner recovered from the image forming section 13. The controller 11 also performs a process of forming an image for forcedly ejecting the toner in the image forming section 13 at a predetermined timing (hereinafter, the image will be referred to as toner band) for the purpose of avoiding a degradation of the toner held in the image forming section 13 or the like. The controller 11 performs the process of forming a toner band, for example, when a power supply of the image forming apparatus 10 is turned on, when a time interval for the image forming process in the image forming section 13 is longer than or equal to a predetermined time, when a user instructs the controller 11 to perform the process, or the like. It should be noted that the controller 11 is an example of the information processing apparatus according to the exemplary embodiment of the present invention. The image data of the above-mentioned specified image is an example of first image data according to the exemplary embodiment of the present invention, and the image data of the toner band is an example of second image data according to the exemplary embodiment of the present invention.

The storage section 12 is a storage device such as a hard disc. The storage section 12 performs write and read of various pieces of data under a control of the controller 11. The storage section 12 previously stores a correction factor table that will be described below, and the correction factor table is read out when the prediction process is carried out.

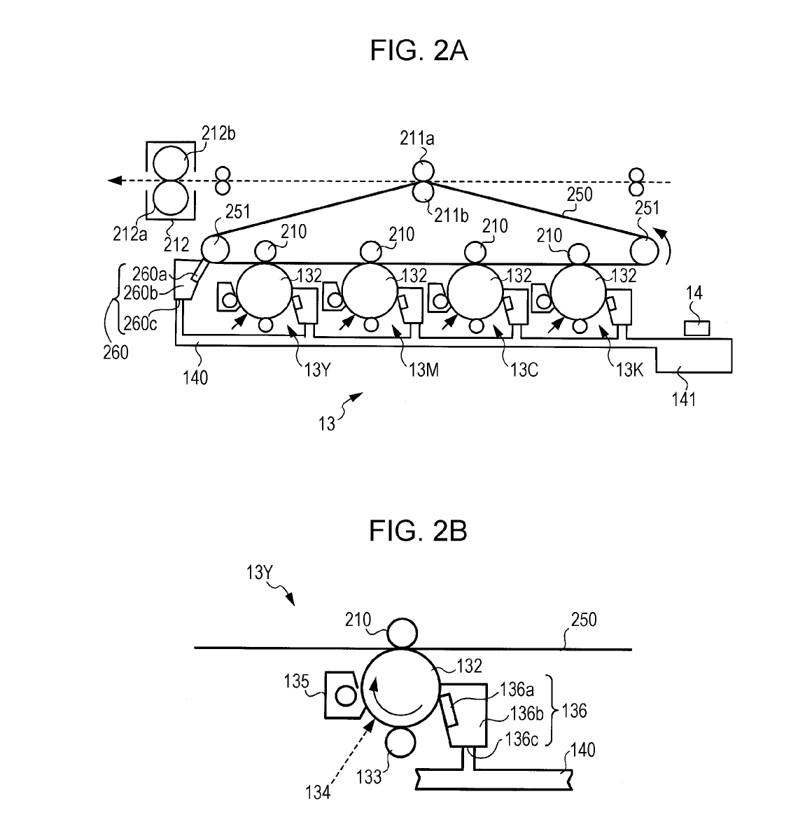

Next, the image forming section 13 will be described. FIG. 2A illustrates a configuration of the image forming section 13 according to the present exemplary embodiment. According to the present exemplary embodiment, an example will be described in which the image forming section 13 forms a color image by an intermediate transfer system using image forming units 13Y, 13M, 13C, and 13K having photoconductor members 132 corresponding to yellow (Y), magenta (M), cyan (C), black (K), respectively. The image forming section 13 forms the color image based on the specified image data on a recording medium such as a sheet while the respective image forming units perform processes such as charging, exposure, development, transfer, and fixing under the control of the controller 11. Hereinafter, the image forming units and peripheral configurations related to the image formation will be described. The configurations of the image forming units 13Y, 13M, 13C, and 13K are common to each other, and the image forming unit 13Y will be described as an example.

FIG. 2B illustrates a configuration example of the image forming unit 13Y. The image forming unit 13Y has the photoconductor member 132, a charging device 133, an exposure device 134, a developing device 135, and a cleaning device 136. The photoconductor member 132 is composed of a cylindrical member having a photoconductive layer on its surface. The photoconductor member 132 holds an electrostatic latent image formed through the exposure on the surface and rotates in a direction of an arrow indicated in FIG. 2B about an axis (in a direction perpendicular to a sheet surface of FIG. 2B) of the photoconductor member 132 by the drive of a motor that is not illustrated in the drawing. The charging device 133 is arranged while being in contact with the surface of the photoconductor member 132 and has a charging roller that is driven and rotated by the rotation of the photoconductor member 132. By applying a voltage to the charging roller by a voltage application section that is not illustrated in the drawing, the charging device 133 charges the surface of the photoconductor member 132 at a certain potential. The exposure device 134 exposes the surface of the photoconductor member 132 with light in accordance with the image data and forms an electrostatic latent image on the surface of the photoconductor member 132. The developing device 135 develops the electrostatic latent image formed on the surface of the photoconductor member 132 by toner that is a developer. The cleaning device 136 is an example of a toner recovery section according to the exemplary embodiment of the present invention. The cleaning device 136 is arranged while being pressed against the surface of the photoconductor member 132 and has a removal member 136a that removes the toner that is not transferred and remains on the surface of the photoconductor member 132 and a container 136b that stores the toner recovered by the removal member 136a. The container 136b has an ejecting outlet 136c for ejecting the toner in the container 136b into a transport path 140 for transporting the toner to a toner recovery container 141 that will be described below.

With reference to FIG. 2A, the peripheral configuration related to the image formation will be described. A first transfer roller 210 is provided at a location facing the photoconductor member 132 via an intermediate transfer belt 250. A first transfer voltage is applied to the photoconductor member 132 via the first transfer roller 210 and the intermediate transfer belt 250 by the voltage application section that is not illustrated in the drawing. The first transfer voltage has a polarity opposite to the polarity at which the toner is charged. Through the application of the first transfer voltage, a potential difference occurs between the photoconductor member 132 and the intermediate transfer belt 250, and the charged toner moves to the intermediate transfer belt 250. The intermediate transfer belt 250 is an endless belt and rotates in the arrow direction while being supported so as to be rotated by plural rollers 251. A second transfer roller 211a and a backup roller 211b are arranged at facing locations while sandwiching the intermediate transfer belt 250 and form a nip part. The recording medium contacts the intermediate transfer belt 250 in the nip part, and while a second transfer voltage is applied to the intermediate transfer belt 250 via the second transfer roller 211a by the voltage application section that is not illustrated in the drawing, the toner image is subjected to a second transfer from the intermediate transfer belt 250 to the recording medium. In a fixing device 212, a fixing roller 212a and a pressurizing roller 212b are arranged while facing each other and form a nip part. While the recording medium is transported in the nip part of the fixing roller 212a and the pressurizing roller 212b, the fixing device 212 fixes the toner image by the heated fixing roller 212a and the pressurizing roller 212b on the recording medium. The recording medium on which the toner image is fixed by the fixing device 212 is discharged through the control of the controller 11.

The cleaning device 260 is an example of the toner recovery section according to the exemplary embodiment of the present invention. The cleaning device 260 removes the toner remaining on the intermediate transfer belt 250 after the toner image is subjected to a second transfer by a removal member 260a, and the removed toner is contained in a container 260b. The container 260b has an ejecting outlet 260c for ejecting the toner to the transport path 140 for transporting the toner in the container 260b to the toner recovery container 141. The toner ejected from the respective ejecting outlets 136c and 260c of the cleaning devices 136 and 260 are transported through the transport path 140 to the toner recovery container 141. The configuration of the image forming section 13 has been described above.

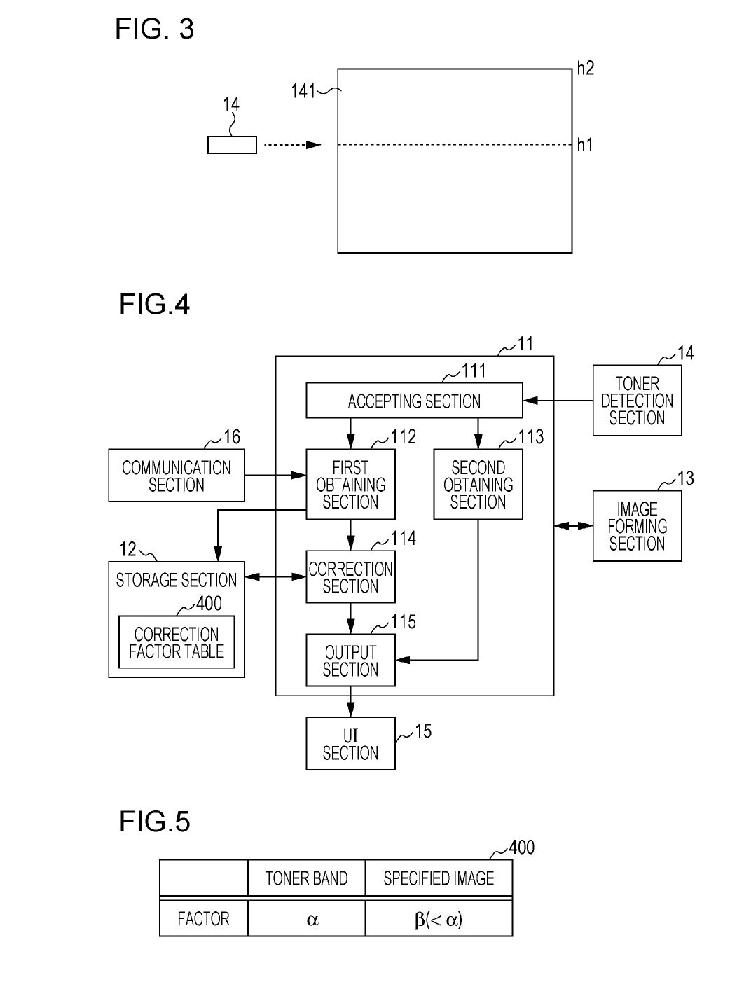

Next, the toner recovery container 141 and the toner detection section 14 will be described. The toner recovery container 141 that is an example of the recovery container according to the exemplary embodiment of the present invention is provided with the toner detection section 14 composed of an optical sensor or the like. FIG. 3 schematically represents the toner recovery container 141. According to the present exemplary embodiment, whether or not the amount of toner deposited in the toner recovery container 141 (hereinafter, referred to as toner deposit amount) reaches a first permissible amount that corresponds to a height h1 of the toner recovery container 141 is detected by the toner detection section 14. A second permissible amount that corresponds to a height h2 of the toner recovery container 141 is an upper limit at which the toner may be contained in the toner recovery container 141. After the toner detection section 14 detects that the toner is deposited to reach the first permissible amount, it is predicted through the prediction process whether or not the toner deposit amount reaches the second permissible amount.

The detection method of detecting whether or not the toner deposit amount reaches the first permissible amount will be described. At a location at the height h1 indicating the first permissible amount on one wall surface in the toner recovery container 141 among two wall surfaces, a light transmissive section (not illustrated) through which light emitted from the toner detection section 14 is transmitted is provided, and a light reception section (not illustrated) that receives the light transmitted through the one wall surface is provided on the other wall surface. The toner detection section 14 detects a state in which the toner is not deposited up to the first permissible amount if the emitted light is received by the light reception section. The toner detection section 14 detects a state in which the toner is deposited to reach the first permissible amount if the emitted light is interrupted by the toner deposited in the toner recovery container 141 and the light is not received by the light reception section. In a case where the state is detected in which the toner is deposited to reach the first permissible amount, the toner detection section 14 outputs information indicating that the toner is deposited to reach the first permissible amount (hereinafter, referred to as deposit information) to the controller 11.

The description will be continued with reference to FIG. 1. A user interface (UI) unit 15 has a touch panel and keys. The UI section 15 sends an operation signal indicating a content of an operation with the touch panel and the keys by a user to the controller 11 and also displays the specified image on the touch panel under the control of the controller 11. The communication section 16 is a communication interface in conformity to a communication protocol such as a wired or wireless LAN and sends data to and receives data from a PC connected so as to perform a communication under the control of the controller 11.

Functional Blocks of the Controller 11

Next, functions related to the prediction process performed by the controller 11 will be described. FIG. 4 is a functional block diagram of the controller 11. As illustrated in FIG. 4, the controller 11 has an accepting section 111, a first obtaining section 112, a second obtaining section 113, a correction section 114, and an output section 115.

The accepting section 111 accepts the deposit information from the toner detection section 14. The first obtaining section 112 obtains pixel count values of image data of the specified image formed through the image forming process by the image forming section 13 and image data of the toner band. To be more specific, in a case where the specified image obtained through the communication section 16 is formed in the image forming section 13, the first obtaining section 112 counts the number of pixels of the image data of the above-mentioned specified image, in other words, the number of exposure dots at a time when the electrostatic latent image is formed on the surface of the photoconductor member 132 as the pixel count value by a dot counter. Also, in a case where the toner band is formed in the image forming section 13 at a predetermined timing, the first obtaining section 112 counts the number of pixels of the image data of the toner band stored in the storage section 12 as the pixel count value. It should be noted that the first obtaining section 112 is an example of a first obtaining part according to the exemplary embodiment of the present invention. Also, when the toner image is formed on the photoconductor member 132, the amount of toner used for the toner image is decided in accordance with the pixel count value. Therefore, the pixel count value represents the toner amount used for the toner image and is an example of an image amount according to the exemplary embodiment of the present invention.

The second obtaining section 113 is an example of a second obtaining part according to the exemplary embodiment of the present invention. The second obtaining section 113 counts the number of pages of the recording medium printed by the image forming section 13. The correction section 114 is an example of a correction part according to the exemplary embodiment of the present invention. The correction section 114 reads out a correction factor in accordance with the image data of the pixel count value obtained in the first obtaining section 112 (the image data of the specified image or the toner band) from a correction factor table in the storage section 12 and multiplies the pixel count value by the read correction factor to correct the pixel count value. The correction factor table will be described.

FIG. 5 exemplifies a configuration and data of the correction factor table. The correction factor table 400 stores factors (α and β) corresponding to the toner band and the specified image. The toner image of the toner band is formed on the photoconductor member 132. The toner image of the specified image is formed on the photoconductor member 132 and is subjected to the first transfer onto the intermediate transfer belt 250. Toner used for the toner image of the toner band formed on the surface of the photoconductor member 132 is almost recovered by the cleaning device 136. Meanwhile, after the toner image of the specified image is subjected to the second transfer onto the recording medium, residual toner of the toner image of the specified image is recovered from the photoconductor member 132 by the cleaning device 136 and residual toner on the intermediate transfer belt 250 is recovered by the cleaning device 260. A residual toner recovery ratio of the toner band is higher than a residual toner recovery ratio of the specified image. For that reason, according to the present exemplary embodiment, for example, the factor of the toner band is set as 1.0, and the factor of the specified image is set as 0.5, so that the factor of the specified image is set to be lower than the factor of the toner band.

The output section 115 is an example of an output part according to the exemplary embodiment of the present invention. The output section 115 outputs notification information for urging a replacement of the toner recovery container 141 to the UI section 15 in accordance with a cumulative value, which is calculated by the correction section 114, of the pixel count value and a cumulative value of the number of pages obtained in the second obtaining section. To be more specific, in a case where one of the cumulative pixel count value and the cumulative page number after reaching the first permissible amount of the toner recovery container 141 exceeds a threshold of the pixel count value or the number of pages each previously set corresponding to the cumulative pixel count value or the cumulative page number with respective to the capacity after reaching the first permissible amount until the second permissible amount is reached, the output section 115 assumes that the toner deposit amount reaches the second permissible amount of the toner recovery container 141 and urges the user to replace the toner recovery container 141. According to the present exemplary embodiment, as indices for predicting the toner deposit amount in the toner recovery container 141, the pixel count value in accordance with the toner band and the specified image and the number of pages of the recording medium are used. According to the present exemplary embodiment, the pixel count value that may be output under a certain condition after reaching the first permissible amount until the second permissible amount is reached and the number of pages of the recording medium corresponding to the pixel count value are set as the respective thresholds.

### Operation Example

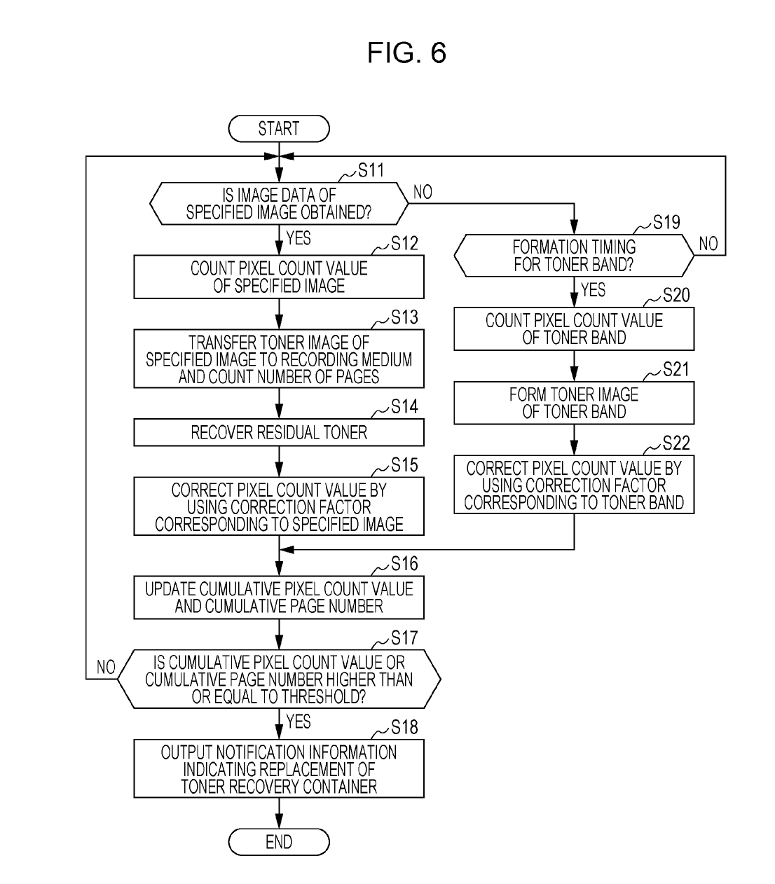

Next, an operation of the image forming apparatus 10 according to the present exemplary embodiment will be described. FIG. 6 is an operational flow illustrating the prediction process by the image forming apparatus 10. Hereinafter, a description will be given of the controller 11 of the image forming apparatus 10 while it is supposed that a state is established in which the deposit information indicating that the toner deposit amount reaches the first permissible amount of the toner recovery container 141 is sent out by the toner detection section 14 and a predetermined region in the storage section 12 stores “0” as initial values for the cumulative pixel count value and the cumulative page number.

In a case where the image data of the specified image is obtained via the communication section 16 (step S11: YES), the controller 11 sends the obtained image data to the image forming section 13, counts the number of pixels of the image data, and temporarily stores the count result in the memory 11b as the pixel count value of the specified image (step S12).

The controller 11 causes the image forming section 13 to form toner images based on the image data on the respective photoconductor members 132, and the toner images are subjected to the first transfer onto the intermediate transfer belt 250. Thereafter, the toner images are subjected to the second transfer onto the recording medium to discharge the recording medium. Also, the controller 11 counts the number of pages of the recording medium subjected to the second transfer and temporarily stores the count result in the memory 11b (step S13). Then, the controller 11 causes the cleaning devices 136 of the image forming section 13 to recover the residual toner on the surfaces of the respective photoconductor members 132 and also causes the cleaning device 260 to recover the residual toner on the intermediate transfer belt 250 (step S14).

The controller 11 reads out the pixel count value stored in the memory 11b in step S12 and also reads out the correction factor β corresponding to the specified image from the correction factor table 400 of the storage section 12 and corrects the pixel count value by multiplying the pixel count value by the correction factor (step S15). The controller 11 adds the pixel count value after the correction to the cumulative pixel count value in the storage section 12 to update the cumulative pixel count value and reads out the number of pages stored in the memory 11b in step S13 to update the cumulative page number by adding the number of pages to the cumulative page number in the storage section 12 (step S16).

The controller 11 determines whether or not one of the cumulative pixel count value and the cumulative page number in the storage section 12 has reached its corresponding predetermined threshold (step S17). In a case where it is determined that one of the cumulative pixel count value and the cumulative page number has reached its corresponding predetermined threshold (step S17: YES), the controller 11 displays an image for urging a replacement of the toner recovery container 141 as notification information on the UI section 15 (step S18). On the other hand, in a case where it is determined that both the cumulative pixel count value and the cumulative page number have not reached the respective predetermined thresholds corresponding to the cumulative pixel count value and the cumulative page number (step S17: NO), the controller 11 returns to step S11 and performs the above-mentioned process.

Also, in a case where the image data of the specified image is not being accepted via the communication section 16 (step S11: NO), for example, when a timing arrives for forming the toner band such as when the power supply of the image forming apparatus 10 is turned on (step S19: YES), the controller 11 counts the pixel count value of the image data of the toner band stored in the storage section 12 and temporarily stores the count result in the memory 11b (step S20). Then, the controller 11 causes the image forming section 13 to form the toner image based on the image data of the toner band (step S21), and causes the cleaning devices 136 of the image forming section 13 to recover the residual toner on the surfaces of the respective photoconductor members 132.

The controller 11 reads out the pixel count value of the toner band stored in the memory 11b. Also, the controller 11 reads out the correction factor α corresponding to the toner band from the correction factor table 400 in the storage section 12 and corrects the pixel count value by multiplying the pixel count value by the correction factor α (step S22). The controller 11 shifts the process to step S16. The controller 11 reads out the cumulative pixel count value in the storage section 12 and adds the pixel count value after the correction to the cumulative pixel count value to update the cumulative pixel count value. The controller 11 performs the process in step S17 and subsequent steps. In step S19, if the timing is not for forming the toner band (step S19: NO), the controller 11 shifts the process to step S11.

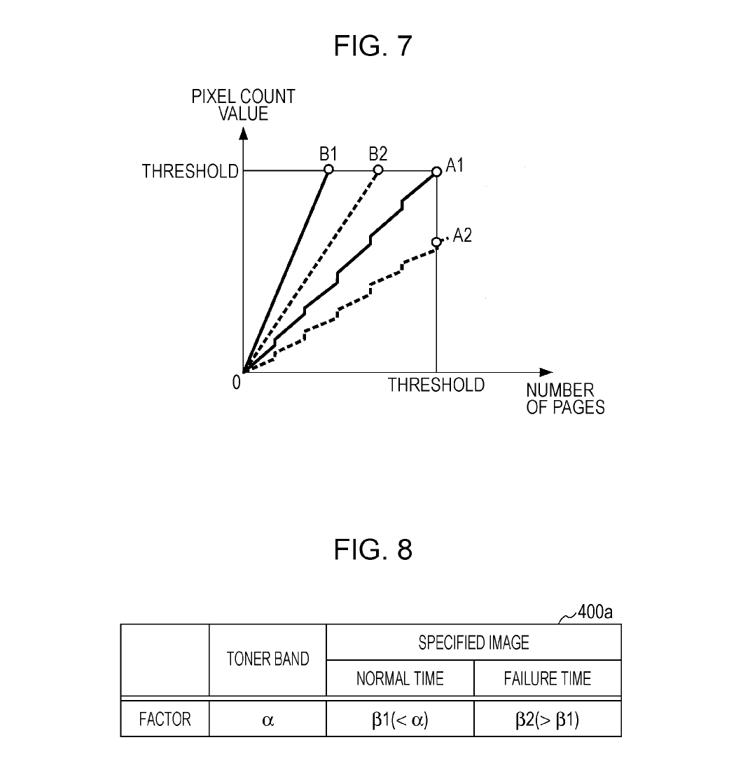

FIG. 7 illustrates transitions of the cumulative pixel count value and the cumulative page number in a case where each of the pixel count values is corrected by using the factor in accordance with the toner band and the specified image and a case where each of the pixel count values is not corrected. In FIG. 7, the transitions in a case where the pixel count value is not corrected are represented by solid lines A1 and B1, and the transitions in a case where the pixel count value is corrected are represented by broken lines A2 and B2. Also, the transitions A1 and A2 represent a case, for example, in which averages of an image density and a full-color ratio are 5% and 20%, respectively, and the transitions B1 and B2 represent a case, for example, in which the averages of the image density and the full-color ratio are 5% and 100%, respectively. The image density is a ratio of pixels of a specified image with respect to a size of the recording medium, and the full-color ratio is a ratio of the number of pages of the recording medium on which the color specified images are transferred with respect to the total number of pages of the recording medium on which the color and monochrome specified images are transferred. The respective thresholds of the number of pages and the pixel count value are the cumulative page number and the cumulative pixel count value that, when the image density is 5% and the full-color ratio is 20%, may be output after reaching the first permissible amount of the toner recovery container 141 until the second permissible amount is reached.

In a case where the full-color ratio is 20%, it is supposed that the toner band is more likely to be formed as compared with a case where the full-color ratio is 100%. For that reason, in the transitions A1 and A2, the page number and the pixel count value increase at a certain gradient each time the specified image is subjected to the image formation, and the page number does not increase and the pixel count value increases each time the toner band is subjected to the image formation. On the other hand, in a case where the full-color ratio is 100%, it is supposed that the toner band is less likely to be formed as compared with a case where the full-color ratio is 20%. For that reason, in the transitions B1 and B2, the transition by the image formation of the toner band is not included, and the page number and the pixel count value increase at a certain gradient each time the specified image is subjected to the image formation. As illustrated in FIG. 7, in the transition B1 where the full-color ratio is higher than in the transition A1, the pixel count value reaches the threshold at a timing earlier than in the transition A1. In conditions for the image density and the full-color ratio of the transitions A1 and B1, in a case where the pixel count values of the respective images are corrected by using the factors corresponding to the specified image and the toner band, the cumulative pixel count values indicated by the transitions A2 and B2 become lower than the transitions A1 and B1 at a certain page number, respectively. As a result, as illustrated in the transition B2, in a condition in which the image density is 5% and the full-color ratio is 100%, the page number when the pixel count value reaches the threshold becomes higher than the case in which the correction is not carried out. This result notably appears in a condition in which the image formation of the toner band is less likely to be carried out, for example, a condition in which the image density is 5% and the full-color ratio is 100%, a condition in which the image density is 20% and the full-color ratio is 20%, or the like. Therefore, by correcting the pixel count value by using the factor in accordance with the specified image and the toner band like the above-mentioned exemplary embodiment, as compared with a case in which the pixel count value is not corrected, the toner deposit amount of the toner recovery container 141 is more accurately predicted, and under a certain condition for the image density and the full-color ratio, the page number that may be output until the toner recovery container 141 is replaced increases.

### Modified Examples

The exemplary embodiment of the present invention has been described, but an exemplary embodiment of the present invention is not limited to the above-mentioned exemplary embodiment and may be implemented in other various modes. For example, the above-mentioned exemplary embodiment may be modified to implement the present invention in the following manner, and respective modified examples may be combined to implement the present invention. Hereinafter, modified examples of the present invention will be described.

(1) According to the above-mentioned exemplary embodiment, the example has been described in which the pixel count values of image data of the toner band and image data of the specified image are corrected by the factors corresponding to the toner band and the specified image, but a configuration may be adopted in which the pixel count value of the image data of the specified image may be corrected by using a factor in accordance with whether or not a failure such as paper jam occurs when the toner image of the specified image is transferred onto the recording medium. In a case where the failure such as paper jam occurs, the ratio of the toner image subjected to the second transfer from the intermediate transfer belt 250 onto the recording medium becomes lower as compared with a case in which the failure does not occur, and therefore the ratio of the toner recovered by the cleaning device 260 from the intermediate transfer belt 250 becomes high as compared with the case in which the failure does not occur. For that reason, in this case, a detection section is provided to detect whether or not the failure such as paper jam occurs, that is, whether or not the toner image of the specified image is transferred onto the recording medium and to output a detection result to the controller 11. Also, as illustrated in a correction factor table 400a of FIG. 8, a factor in a case of the toner band, and a factor in a normal case in which the failure such as paper jam does not occur and a factor in the failure occurrence in the case of the specified image are previously stored, where a factor β2 in the case of the failure occurrence is set as a value higher than a factor β1 in the normal case.

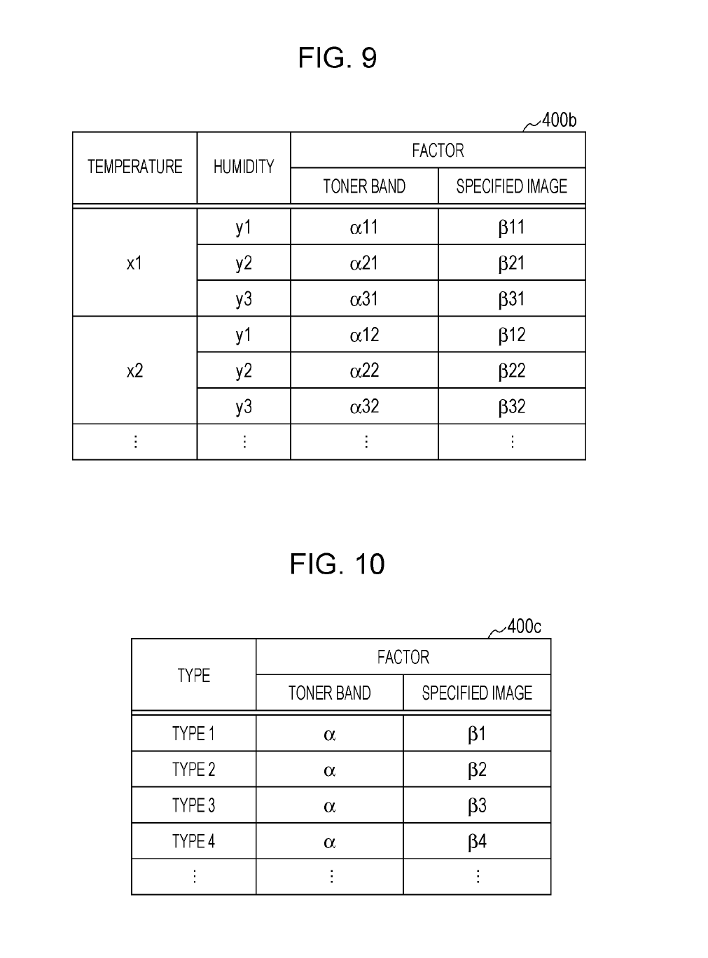

(2) In the above-mentioned exemplary embodiment, the pixel count values of the image data of the toner band and the image data of the specified image may be corrected using factors with respect to the toner band and the specified image in accordance with a temperature and a humidity in the image forming apparatus 10. In this case, a sensor that detects the temperature and the humidity in the image forming apparatus 10 as environment information is provided. The ratio at which the toner image of the specified image is transferred onto the recording medium changes depending on the temperature and the humidity in the image forming apparatus 10, and therefore, as illustrated in FIG. 9, the respective factors with respect to the toner band and the specified image in accordance with the temperature and the humidity in the image forming apparatus 10 in the image forming process may be previously stored in a correction factor table 400b. Also, information indicating the temperature and the humidity is substituted in a computing expression for correcting the predetermined respective factors of the toner band and the specified image to obtain the respective factors through the computation. According to the present modified example, the example has been described in which the factors of the toner band and the specified image corresponding to the temperature and the humidity are used, but factors of the toner band and the specified image corresponding to environment information on one of the temperature and the humidity may be used.

(3) In the above-mentioned exemplary embodiment, the pixel count values of the image data of the toner band and the image data of the specified image may be corrected using the respective factors of the toner band and the specified image in accordance with a type of the recording medium on which the specified image is transferred (for example, normal paper, glossy paper, embossed paper, or the like). The ratio at which the toner image of the specified image is transferred onto the recording medium changes depending on the type of the recording medium, and therefore, as illustrated in FIG. 10, the respective factors corresponding to the toner band and the specified image may be previously stored in a correction factor table 400c in accordance with the type of the recording medium on which the toner image of the specified image is transferred. Also, the respective factors may be obtained through information indicating the type of the recording medium and a predetermined computing expression for correcting the respective factors of the toner band and the specified image. In this case, the controller 11 obtains type information indicating the type of the recording medium via the UI section 15 and selects a factor in accordance with the obtained type information and the image formed on the intermediate transfer belt 250 from the correction factor table 400c to correct the pixel count value of the image. In the correction factor table 400c, a common value is set as the factor of the toner band since the toner image of the toner band is not transferred onto the recording medium.

(4) In the above-mentioned exemplary embodiment, the pixel count values of the image data of the toner band and the image data of the specified image may be corrected using the respective factors of the toner band and the specified image in accordance with a process speed in the image forming section 13. In this case, the factors corresponding to the toner band and the specified image for each predetermined process speed are stored in the correction factor table.

(5) According to the above-mentioned exemplary embodiment, the example has been described in which the toner band is formed at a predetermined timing for avoiding the degradation of the toner in the image forming apparatus 10, but if a frequency at which the toner image is formed on the respective photoconductor members 132 in the image forming section 13 is low, the removal members 136a of the cleaning devices 136 of the respective photoconductor members 132 are likely to wear. For that reason, for the purpose of protecting the removal members 136a of the respective cleaning devices 136, for example, when the power supply of the image forming apparatus 10 is turned on or in a case where a temporal interval between operations of the toner image of the specified image being formed on the respective photoconductor members 132 is longer than or equal to a predetermined period of time, the toner band may be formed in the image forming section 13 at the relevant timing.

(6) According to the above-mentioned exemplary embodiment, the example has been described in which whether or not the toner deposit amount of the toner recovery container 141 reaches the second permissible amount is determined by using the cumulative value of the number of pages where the toner image with respect to the specified image is transferred onto the recording medium and the cumulative value of the respective pixel count values of the specified image and the toner band. Whether or not the toner deposit amount reaches the second permissible amount may be determined on the basis of the cumulative value of the respective pixel count values of the specified image and the toner band.

(7) According to the above-mentioned exemplary embodiment, the example has been described in which the correction factor table 400 is previously stored in the storage section 12, but for example, the correction factor table 400 may be obtained from an external apparatus connected to the image forming apparatus 10 via the communication section 16.

(8) According to the above-mentioned exemplary embodiment and modified examples, the example has been described in which the prediction process on the toner deposit amount in the toner recovery container 141 is carried out in the image forming apparatus 10 including the information processing apparatus according to the exemplary embodiment of the present invention, but an apparatus provided with functions related to the prediction process by the controller 11 such as a PC or a server that is connected to an image forming apparatus via a communication section may be configured as the information processing apparatus.

(9) According to the above-mentioned exemplary embodiment, the example has been described in which the image for urging the replacement of the toner recovery container 141 is displayed on the UI section 15 for the notification in a case where the cumulative page number or the cumulative pixel count value reaches its corresponding threshold. As the notification information, for example, an LED may be caused to light up in a case where the cumulative page number or the cumulative pixel count value reaches its corresponding threshold, or information indicating difference between the current cumulative page number and the corresponding threshold and difference between the current cumulative pixel count value and the corresponding threshold may be displayed on the UI section 15.

(10) The image forming section according to the above-mentioned exemplary embodiment and modified examples may be provided with a rotary-system developing device in which plural developing devices are arranged in a circumferential direction of a rotational body, or may be an image forming section forming a monochrome image.

(11) The program executed by the CPU 11a according to the exemplary embodiment and modified examples may be provided in a state of being stored on a computer-readable recording medium such as a magnetic recording medium (a magnetic tape, a magnetic disc, or the like), an optical recording medium (an optical disc or the like), an opto-magnetic recording medium, or a semiconductor memory. Also, the program may be downloaded to the information processing apparatus or the image forming apparatus using a communication part, for example, through the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus for an image forming apparatus including an image forming section that forms a toner image based on first image data that is transferred onto a recording medium and a toner image based on second image data that is not transferred onto the recording medium and a toner recovery section that recovers residual toner in the image forming section to a recovery container, the information processing apparatus comprising:
a first obtaining part that obtains each of image amounts representing toner amounts used for the respective toner images of the first image data and the second image data that are formed by the image forming apparatus in a case where a toner amount recovered to the recovery container reaches a predetermined first permissible amount;
a correction part that corrects the respective image amounts of the first image data and the second image data obtained by the first obtaining part by using a correction factor previously set for each of the first image data and the second image data; and
an output part that outputs notification information indicating that the toner amount in the recovery container reaches a second permissible amount in a case where a cumulative value obtained by combining the image amount of the first image data and the image amount of the second image data that are corrected by the correction part reaches a predetermined first threshold.

2. The information processing apparatus according to claim 1, further comprising:
a second obtaining part that obtains a number of recording media on which the toner image of the first image data is transferred in a case where the toner amount recovered to the recovery container reaches the predetermined first permissible amount,
wherein the output part outputs the notification information in a case where the number of recording media obtained by the second obtaining part reaches a second threshold indicating a number of recording media corresponding to the first threshold.

3. The information processing apparatus according to claim 1, wherein
the correction part corrects the image amount of the first image data by using the correction factor for the first image data that is determined in accordance with whether or not the toner image of the first image data is transferred to the recording medium in the image forming apparatus.

4. The information processing apparatus according to claim 2, wherein
the correction part corrects the image amount of the first image data by using the correction factor for the first image data that is determined in accordance with whether or not the toner image of the first image data is transferred to the recording medium in the image forming apparatus.

5. The information processing apparatus according to claim 1, wherein
the correction part corrects the image amount of the first image data by using the correction factor for the first image data corresponding to environment information indicating at least one of a temperature and a humidity in the image forming apparatus.

6. The information processing apparatus according to claim 2, wherein
the correction part corrects the image amount of the first image data by using the correction factor for the first image data corresponding to environment information indicating at least one of a temperature and a humidity in the image forming apparatus.

7. The information processing apparatus according to claim 3, wherein
the correction part corrects the image amount of the first image data by using the correction factor for the first image data corresponding to environment information indicating at least one of a temperature and a humidity in the image forming apparatus.

8. The information processing apparatus according to claim 4, wherein
the correction part corrects the image amount of the first image data by using the correction factor for the first image data corresponding to environment information indicating at least one of a temperature and a humidity in the image forming apparatus.

9. The information processing apparatus according to claim 1, wherein
the correction part corrects the image amount of the first image data by using the correction factor for the first image data in accordance with a type of the recording medium on which the toner image of the first image data is transferred in the image forming apparatus.

10. The information processing apparatus according to claim 2, wherein
the correction part corrects the image amount of the first image data by using the correction factor for the first image data in accordance with a type of the recording medium on which the toner image of the first image data is transferred in the image forming apparatus.

11. The information processing apparatus according to claim 3, wherein
the correction part corrects the image amount of the first image data by using the correction factor for the first image data in accordance with a type of the recording medium on which the toner image of the first image data is transferred in the image forming apparatus.

12. The information processing apparatus according to claim 4, wherein
the correction part corrects the image amount of the first image data by using the correction factor for the first image data in accordance with a type of the recording medium on which the toner image of the first image data is transferred in the image forming apparatus.

13. The information processing apparatus according to claim 5, wherein
the correction part corrects the image amount of the first image data by using the correction factor for the first image data in accordance with a type of the recording medium on which the toner image of the first image data is transferred in the image forming apparatus.

14. The information processing apparatus according to claim 6, wherein
the correction part corrects the image amount of the first image data by using the correction factor for the first image data in accordance with a type of the recording medium on which the toner image of the first image data is transferred in the image forming apparatus.

15. The information processing apparatus according to claim 7, wherein
the correction part corrects the image amount of the first image data by using the correction factor for the first image data in accordance with a type of the recording medium on which the toner image of the first image data is transferred in the image forming apparatus.

16. The information processing apparatus according to claim 8, wherein
the correction part corrects the image amount of the first image data by using the correction factor for the first image data in accordance with a type of the recording medium on which the toner image of the first image data is transferred in the image forming apparatus.

17. An image forming apparatus comprising:
an image forming part that forms a toner image based on first image data that is transferred onto a recording medium and a toner image based on second image data that is not transferred onto the recording medium;
a toner recovery part that recovers residual toner in the image forming part to a recovery container;
a first obtaining part that obtains each of image amounts representing toner amounts used for the respective toner images of the first image data and the second image data that are formed by the image forming part in a case where a toner amount recovered to the recovery container reaches a predetermined first permissible amount;
a correction part that corrects the respective image amounts of the first image data and the second image data obtained by the first obtaining part by using a correction factor previously set for each of the first image data and the second image data; and
an output part that outputs notification information indicating that the toner amount in the recovery container reaches a second permissible amount in a case where a cumulative value obtained by combining the image amount of the first image data and the image amount of the second image data that are corrected by the correction part reaches a predetermined first threshold.

18. A computer readable medium storing a program causing a computer to execute a process for an image forming apparatus including an image forming section that forms a toner image based on first image data that is transferred onto a recording medium and a toner image based on second image data that is not transferred onto the recording medium and a toner recovery section that recovers residual toner in the image forming section to a recovery container, the process comprising:
obtaining each of image amounts representing toner amounts used for the respective toner images of the first image data and the second image data that are formed by the image forming apparatus in a case where a toner amount recovered to the recovery container reaches a predetermined first permissible amount;
correcting the respective obtained image amounts of the first image data and the second image data by using a correction factor previously set for each of the first image data and the second image data; and
outputting notification information indicating that the toner amount in the recovery container reaches a second permissible amount in a case where a cumulative value obtained by combining the corrected image amount of the first image data and the corrected image amount of the second image data reaches a predetermined first threshold.

19. An information processing method for an image forming apparatus including an image forming section that forms a toner image based on first image data that is transferred onto a recording medium and a toner image based on second image data that is not transferred onto the recording medium and a toner recovery section that recovers residual toner in the image forming section to a recovery container, the information processing method comprising:
obtaining each of image amounts representing toner amounts used for the respective toner images of the first image data and the second image data that are formed by the image forming apparatus in a case where a toner amount recovered to the recovery container reaches a predetermined first permissible amount;
correcting the respective obtained image amounts of the first image data and the second image data by using a correction factor previously set for each of the first image data and the second image data; and
outputting notification information indicating that the toner amount in the recovery container reaches a second permissible amount in a case where a cumulative value obtained by combining the corrected image amount of the first image data and the corrected image amount of the second image data reaches a predetermined first threshold.
